(19) United States
(12) Patent Application Publication
(10) Pub. No.: US 2007/0196045 A1
(43) Pub. Date: Aug. 23, 2007

(54) Method of coupling an electromagnetic signal between a signal source and a waveguide

(76) Inventor: John Mansbridge, Stockbridge Hampshire (GB)

Correspondence Address: SCHIFF HARDIN, LLP;PATENT DEPARTMENT, 6600 SEARS TOWER, CHICAGO, IL, 60606-6473, US

(21) Appl. No.: 10/592,197

(22) PCT Filed: Jan. 17, 2005
(86) PCT No.: PCT/GB05/00185

§ 371 Date: Sep. 8, 2006

(30) Foreign Application Priority Data
Mar. 15, 2004 (GB) 0405682.6

(51) Int. Cl. G02B 6/26

(52) U.S. Cl. 385/31; 385/25

(57) ABSTRACT

In a method for coupling an electromagnetic signal between an electromagnetic signal source and an electromagnetic waveguide, wherein, in use, there is relative movement between the source and the waveguide, at each side where the source is launched into the waveguide, the properties of the waveguide are modified to permit the signal to be coupled into the waveguide, and the signal is launched into the waveguide at each site. At each site, the modification is reversed after launching the signal, so that the signal launched into the waveguide propagates along the waveguide. The process is repeated for each launch site along the waveguide. An electromagnetic coupler operates according to this method.

This invention relates to a method of coupling an electromagnetic signal between an electromagnetic signal source and an electromagnetic waveguide, in particular for an optical signal.

The use of optical fibres to carry information is becoming increasingly common. There are a number of applications where the information must be transferred between two parts of a system that have a relative motion. A typical situation is where the information is being generated on a rotating element (e.g. a sensor on a rotating wheel) and needs to be transferred to the stationary part of the system for processing and display/storage. In many circumstances the transfer can be achieved by using a length of optical fibre and allowing the flexibility of the fibre to enable the rotation of the elements whilst maintaining the required connection. However, clearly for a system such as wheel where the wheel can rotate many times the limited flexibility of the fibre will limit the number of revolutions before the fibre will break.

Currently, the solution for this requirement is to use an optical rotating joint (ORJ). These are well known devices that can be used to transfer the information across a rotating interface. However, this type of device has a severe limitation in that it must be mounted on the axis of rotation of the system and there are many applications where it is not possible to use this axis. For example for sensors on a wheel the axle of the wheel may be a solid body that occupies the axis of rotation and although space can be made available on the axis this may weaken the mechanical strength of the systems and may thus be undesirable. There are also applications where other services, such as fluids, must be passed across the rotating interface and these are most effectively achieved by mounting a rotating coupling on the axis of rotation. Thus, there is very strong competition for space on the axis of rotation and this can make the use of an ORJ inconvenient or impossible in many applications.

In accordance with a first aspect of the present invention, a method of coupling an electromagnetic signal between an electromagnetic signal source and an electromagnetic waveguide, wherein, in use, there is relative movement between the source and the waveguide comprises, at each site where the source is launched into the waveguide, modifying the properties of the waveguide to permit the signal to be coupled into the waveguide; launching the signal into the waveguide; reversing the modification at that site, such that a signal once launched propagates along the waveguide; and repeating the process for each launch site along the waveguide.

In accordance with a second aspect of the present invention, an electromagnetic signal coupler comprises a waveguide and a controller associated with an electromagnetic signal source; wherein, in use, there is relative movement between the source and the waveguide; wherein the controller causes selective modification of the waveguide at a site where the source is being launched into the waveguide, to permit the signal to be coupled into the waveguide; reverses the modification as the source moves away from that site; and repeats the process for each launch site along the waveguide.

Preferably, the waveguide is stationary and the source is moving.

Preferably, electromagnetic energy that has propagated along the waveguide, exits through the end of the waveguide.

Preferably, at least one gap is provided in a substantially continuous waveguide ring to enable data to be extracted.

Preferably, loss of data from the signal source passing over the at least one gap is avoided by increasing the rate of transmission at all other sites and preventing transmission in the gap.

Preferably, the number of sources equals the number of gaps; arranged such that only one source is over a gap at any one time; and wherein data extracted from the waveguide is combined to provide a continuous data stream.

Preferably, the electromagnetic signal source is an optical signal source.

Preferably, the signal is output through an optical fibre coupled to the end of the waveguide.

Preferably, the waveguide comprises a surface incorporating a variable grating or surface coating.

Preferably, the grating or surface coating comprises one of a magneto-optic, electro-optic, acousto-optic or light sensitive material.

Preferably, the waveguide comprises an optical fibre having a fluorescent core or cladding.

An example of a method of coupling an electromagnetic signal between an electromagnetic signal source and an electromagnetic waveguide according to the present invention and an example of an electromagnetic signal coupler will now be described and contrasted with the prior art with reference to the accompanying drawings in which:

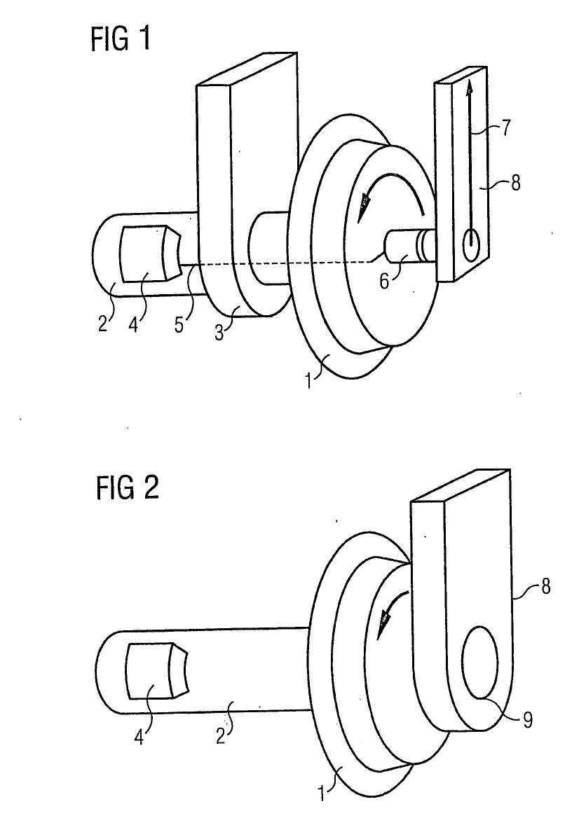

FIG. 1 illustrates an example in which it is possible to use a conventional optical rotating joint to transfer data from a rotating part to a stationary part;

FIG. 2 illustrates an example in which it is not possible to use a conventional optical rotating joint to transfer data from a rotating part to a stationary part;

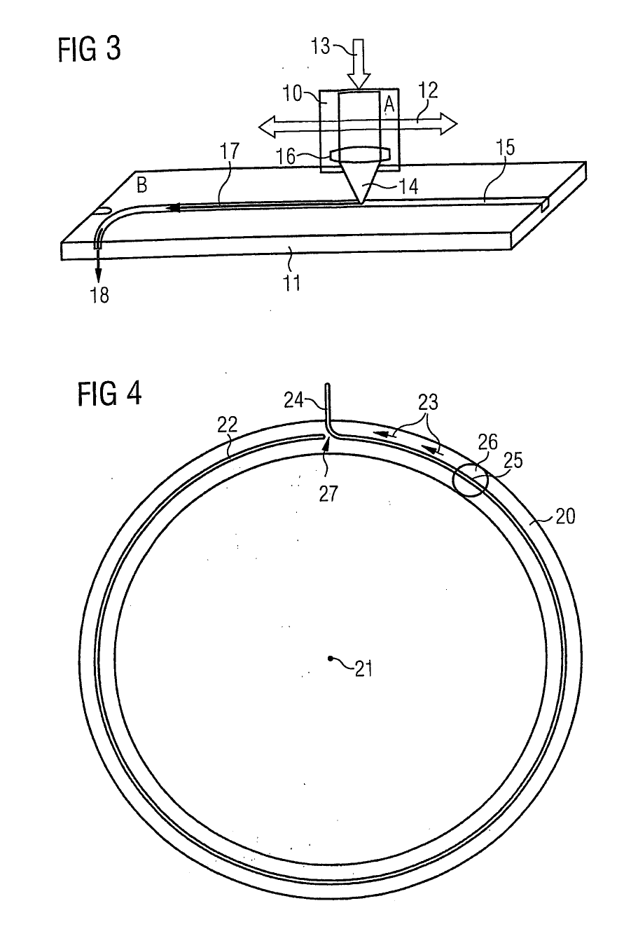

FIG. 3 illustrates a first example of the present invention in which data is transferred from a moving part to a stationary part in accordance with the present invention;

FIG. 4 illustrates a second example of the present invention, adapted for rotational motion, in which data is transferred from a moving part to a stationary part in accordance with the present invention;

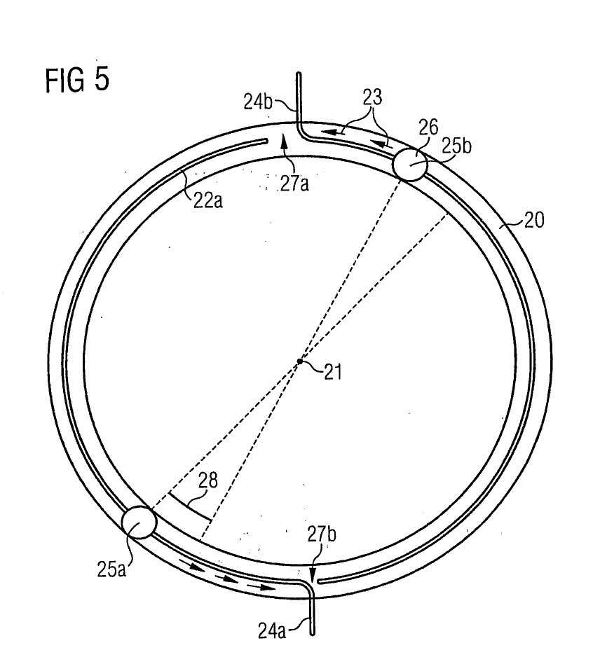

FIG. 5 illustrates an alternative arrangement for the example of FIG. 4;

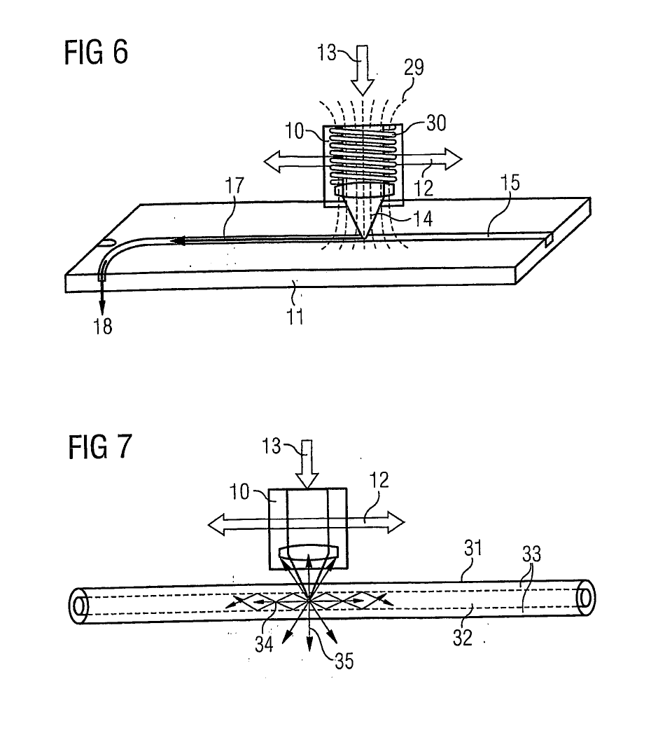

FIG. 6 illustrates one method of coupling a signal to a waveguide in accordance with the present invention in more detail; and,

FIG. 7 illustrates an alternative method for use with the examples of FIG. 3, 4 or 5.

FIG. 1 illustrates a first example of coupling an optical signal in which the use of on ORJ is possible. A wheel 1 rotates on an axle 2 mounted in a bearing 3 for rotation. Sensors 4 on the axle 2 are connected via an optical fibre 5 to an ORJ 6. Information is transferred from the sensors 3 on the rotating part of the wheel to an optical fibre 7 mounted on a stationary part 8. In FIG. 1 the bearing arrangement allows the ORJ to be mounted on the axis of the axle, but outside it.

FIG. 2 illustrates an example in which the user of an ORJ is not possible. In FIG. 2 the arrangement of the solid external bearing 9 is such that an ORJ would have to be mounted too far outside of the wheel 1 to be feasible.

If the axis of rotation is not available, such as shown in FIG. 2, then a manufacturer must often revert to the use of electrical signals that can be passed across an electrical slip ring. The use of electrical signals involves the manufacturer in a wide range of issues. For example, electrical interference from or to the electrical signal(s) can require considerable design effort to eliminate and can also require substantial shielding that would increase the cost, weight or size of the system. Often the electrical signals are a lower bandwidth than the optical signal and a single ORJ must be replaced by several electrical slip rings. This again increases complexity and cost for the system.

In addition to rotating systems there are applications where the movement is linear, such as transferring data from a moving train to a trackside receiving system. An ORJ cannot address this type of requirement and the optical equivalent of a slip ring is required.

The present invention addresses these problems and in one embodiment, it provides an optical equivalent of an electrical slip ring. This has the advantage of being deployable on rotating systems in circumstances where ORJs cannot be and has wider applications to non-rotating systems.

The basic approach of the present invention is illustrated in FIG. 3. The illustration shows two parts, parts A 10 and B 11, that have a relative motion as illustrated by arrow 12. An optical fibre 13 with information to be transmitted between the two parts 10, 11 is attached to Part A. A focussed beam of light 14 is projected onto a waveguide 15 formed into Part B 11. The light is focused onto the waveguide by a lens arrangement 16. The light is coupled 17 into the waveguide 15 and travels along the waveguide until it exits 18 the waveguide into an output optical fibre. Thus as the two parts 10, 11 move relative to each other, the point at which the light 14 is launched into the waveguide 15 moves along the waveguide, but the light continues to exit the waveguide through the output fibre.

This approach can be used to form a circular slip ring for rotating applications, as illustrated in FIG. 4. In this example, the stationary part 20 is a ring about an axis of rotation 21 with a waveguide 22 forming an almost full ring mounted on it. Light propagates 23 along the waveguide. The waveguide ‘ring’ is broken to lead the light out of the waveguide to the output optical fibre 24. This arrangement leads to a break in the propagation as the launch point 25 for the light, in the rotating part 26, crosses the break 27 in the waveguide ring. To prevent an unacceptable loss of communication at this point, there are various techniques which can be applied. For example, one option is to transmit the information at a marginally higher rate, so that information that would have been sent during the traversal of the gap can be stored and sent during the reminded of the rotation period. Alternatively, Forward Error Correction (FEC) techniques can be applied to enable the data to be recovered despite the drop-out at the gap.

FIG. 5 illustrates a structural change to the waveguide 22 to deal with the loss of communication, whereby the waveguide ring is divided into two sections 22a, 22b and two launch points 25a, 25b are used, arranged to ensure that only one launch point is over a gap 27a, 27b at any time by adjusting the angular displacement 28 accordingly. In this case there are two outputs 24a, 24b and these need to be fed to a system that can select the appropriate information stream to ensure the stream is continuous.

A fundamental consideration of the present invention is that if it is possible to launch light into a waveguide, then light will also tend to leak out of the waveguide. This causes unacceptable loss in the waveguide. The total loss between the launch point and the output fibre also varies with the launch position, which causes additional complications. In principle, the more efficient the launch of the light, the greater the loss in the waveguide. Overcoming this limitation is an important requirement for implementing the present invention.

One known technique that can be used to optimise launch efficiency vs. waveguide loss is described by Chen et al in “Fully Embedded Board-Level Guided-Wave Optoelectronic Interconnects”—Proc. IEEE Vol. 88, No. 6, June 2000. This describes a number of techniques that can be used to launch light into waveguides embedded into planar materials. One of the properties of the coupling structure described is that efficient coupling (35%) of the light into the waveguide is possible, but that light already travelling in the waveguide and passing the coupler couples out at a very low efficiency of <1%. Thus it is possible to arrange a continuous line of these couplers along the length of the waveguide so that light can be coupled in at any point along the waveguide. The coupling is achieved using gratings fabricated into the surface of the waveguides.

To improve the coupling/waveguide loss performance of the invention, a number of techniques are available. These are based on modifying the properties of the waveguide at the launch point. Thus the coupler can be made to have good coupling performance at the launch point. This can be at the expense of higher loss at this point. Because this higher loss occurs only at the coupling point it will be more acceptable.

An implementation of this is illustrated in FIG. 6. A coupler is manufactured from a material for which the coupling performance can be modified locally around the launch point. In one example, the coupling is mediated by a grating formed in the waveguide 15 from a magneto-optical material. The grating is formed from alternately poled layers of magneto-optic material. Thus, in the absence of a magnetic field 29 the grating is very weak because the layers exhibit the same refractive index, whereas on application of the magnetic field the layers have diverging refractive indices and form, locally, a very much stronger grating, which could be arranged to have high coupling efficiency. A coil 30 is placed in Part A to alter the properties of the waveguide locally at the launch point by applying the magnetic field.

Equally, other physical phenomena could be applied to affect the waveguide locally. For example, by use of an electro-optic effect, in which an electrostatic field replaces the magnetic field and locally alters the coupling via the electro-optic effect or, by evanescent coupling, where the gap between the material carrying the light in Part A 10 and the waveguide 15 could be made sufficiently small that presence of the material itself would locally affect the coupling. Alternatively, optical interactions, such as local illumination of the waveguide, typically with a wavelength different from the information-carrying wavelength, can be arranged to change the properties of the waveguide or acousto-optic means using sound injected locally to change the waveguide properties can be utilised.

Alternative mechanisms to provided coupling which do not require a grating structure, include the use of a coating on the surface of the waveguide that would normally reflect the light, thus keeping the light within the waveguide, but that could be locally modified to allow light to pass though at the launch site, or using fluorescence. An example of coupling using fluorescence is given in FIG. 7. Light is injected into the optical fibre 31 at one wavelength and is absorbed in fluorescent material incorporated into the core 32, or cladding 33 of the fibre. The absorption of light promotes the fluorescent material into a higher energy state, which then decays emitting light at different wavelengths. The light emitted is isotropic and therefore any light within the collection angle of the fibre will propagate 34 in fibre as illustrated in FIG. 7 and all other light will simply pass through 35 the fibre.

The present invention provides a slip ring that enables an electromagnetic signal, in particular an optical one, to be transmitted between a waveguide on one part and a waveguide on a second part where the two parts are in relative motion. Efficient transfer of the signal is obtained by the use of coupling techniques that maximise the coupling of the signal between the waveguides whilst minimising any unwanted coupling out of the signal during its transmission along the remainder of the guide. A slip ring of this type enables communication between moving parts in a wide range of systems, such as between a moving vehicle and a road or track-side receiver.

An important application of the present invention is the transfer of data across a rotating interface in a machine where a standard rotating joint cannot be used because the axis of rotation is not available. A particular example of this is in computerised axial tomography (CAT) or computed tomography (CT) scanners for medical applications, where an X-ray tube and radiation detectors rotate around a body and data received at the rotating radiation detectors must be transferred to a computer for calculation of what was in the path of the X-rays, so that this can be displayed that for a medical professional to interpret. Use of an optical rotating joint is not practical because it would need to be mounted on the axis, which is where the body is positioned for scanning. Conventionally, the data transfer has been by electrical slip rings or Radio Frequency techniques, but the problems with this are these techniques are running out of data transfer capacity, require large mechanical assemblies and are prone to electromagnetic interference problems.

These examples of the present invention have been described in terms of optical signals. However, it should be noted that a number of the implementations are also applicable to other parts of the electromagnetic spectrum, in particular to microwaves.

1. A method of coupling an electromagnetic signal between an electromagnetic signal source associated with a controller and an electromagnetic waveguide, wherein, in use, there is relative movement between the source and the waveguide; the method comprising, at each site where the source is launched into the waveguide, the controller causing selective modification of the properties of the waveguide to permit the signal to be coupled into the waveguide; launching the signal into the waveguide; reversing the modification at that site, such that a signal once launched propagates along the waveguide; and repeating the process for each launch site along the waveguide.

2. A method according to claim 1, comprising maintaining the waveguide stationary and moving the source.

3. A method according to claim 1 comprising allowing electromagnetic energy that has propagated along the waveguide, to exit through an end of the waveguide.

4. A method according to claim 1 comprising providing at least one gap is provided in a substantially continuous waveguide ring to enable data to be extracted.

5. A method according to claim 4, comprising avoiding loss of data from the signal source passing over the at least one gap by increasing a rate of transmission at all other sites and preventing transmission in the gap.

6. A method according to claim 4, comprising providing a number of sources equal to a number of gaps arranged with only one source over the gap at any one time, and combining data extracted from the waveguide is to provide a continuous data stream.

7. A method according to claim 1, comprising employing an optical signal source as said electromagnetic signal source.

8. An electromagnetic signal coupler comprising a waveguide and a controller associated with an electromagnetic signal source; wherein, in use, there is relative movement between the source and the waveguide, said controller selectively modifying the waveguide at a site where the source is being launched into the waveguide, to permit the signal to be coupled into the waveguide, and reversing the modification as the source moves away from that site, and repeats the process for each launch site along the waveguide.

9. A coupler according to claim 8, wherein the waveguide is stationary and the source is moving.

10. A coupler according to claim 8, wherein electromagnetic energy that has propagated along the waveguide, exits at an end of the waveguide.

11. A coupler according to claim 8, wherein said waveguide is a substantially continuous waveguide ring having at least one gap therein to enable data to be extracted from the waveguide.

12. A coupler according to claim 11, wherein a number of sources equals a number of gaps with said sources arranged such that only one source is over a gap at any one time; and wherein data extracted from the waveguide are combined to provide a continuous data stream.

13. A coupler according to claim 8, wherein said source emits an optical signal as the electromagnetic signal.

14. A coupler according to claim 13, comprising an optical fiber through which the signal is output, said optical being coupled to an end of the waveguide.

15. A coupler according to claim 13, wherein the waveguide comprises a surface incorporating a variable grating or surface coating.

16. A coupler according to claim 15, wherein the grating or surface coating is formed of a material selected from the group consisting of magneto-optic material, electro-optic material, acousto-optic material and light sensitive material.

17. A coupler according to claim 8, wherein the waveguide comprises an optical fiber having a fluorescent core or cladding.
